(19) United States
(12) Patent Application Publication
(10) Pub. No.: US 2020/0036324 A1
(43) Pub. Date: Jan. 30, 2020

(54) Methods of Producing Multiple Output Solar and Water Generator and Radiant Heater

(71) Applicants: Joachim Obeto, Antioch, TN (US); Ab Mobasher, Riggins, ID (US)

(72) Inventors: Joachim Obeto, Antioch, TN (US); Ab Mobasher, Riggins, ID (US)

(21) Appl. No.: 16/420,699

(22) Filed: May 23, 2019

Related U.S. Application Data
(60) Provisional application No. 62/675,175, filed on May 23, 2018.

(51) Int. Cl. H02S 20/32; F24S 20/40; F24S 20/30; H02S 40/44

(52) U.S. Cl. CPC H02S 20/32; H02S 40/44; F24S 20/30; F24S 20/40

(57) ABSTRACT

A combination of multiple cycle solar generator, heat exchanger, dew harvesting and bi-directional heat processing apparatus. Solar energy is collected by a hemispherical, square or other shaped collectors. Current invention converts solar energy in multiple cycles, extracting solar energy through Photo Voltaic cells, making electricity. Focused energy produces heat that is also extracted though Heat Exchangers, combined with Thermo Electric Modules, creating electricity or surplus heat for heating, storage or cooling. Current invention further utilizes large radiator plates in the back of dish along with entire metal assembly for dew harvesting at night or when Thermo Electric modules within heat exchangers energized by stored electricity or power grid. Current invention also operates in reverse for absorbing heat from the atmosphere, water, dirt, ice or snow and diverts the piped heat to desired location.

### CROSS REFERENCE TO RELATED APPLICATION

This application claims the benefit of and priority to U.S. Patent Application No. 62/675,175, a pending provisional patent application, filed on May 23, 2018, and the entire disclosure of which is incorporated by reference herein.

### BACKGROUND OF THE INVENTION

A system of manufacturing, multiple output generator for production of electricity by utilizing concentrated solar light and heat over photovoltaic cells, whilst utilizing the generated heat, processed through thermo electric or other means and venting (radiating) heat through series radiator plates as well as metal frameworks, thereby capitalizing in difference between hot and cold and generating electricity. Radiator plates and other metal surfaces further utilized passively (during night or when cold) to capture moisture from air by condensation of dew, collecting water. Same metallic surfaces further can be chilled, utilizing the reverse process by charging the thermo electric modules and pumping (extracting) heat form radiator plates or metal frames and venting (radiating) the heat though the concentrator dish, thereby using electricity generated earlier for chilling said surfaces and inducing dew condensation and collection of water from air.

Current invention works in reverse; absorbing heat from ambient air through radiator plates and frame, heat then extracted with Thermo Electric modules within heat Exchangers, and radiated forward through the dish, heating the desired direction.

### Field of Invention

The present invention configured as multiple functional solar dish for generating electricity and collection or utilization of moisture and heat from the air.

### Description of Known Art

Varieties of solar collection devices are made for capturing solar ray by either direct or concentration of solar rays for conversion to electricity through use of photovoltaic solar cells, heating water or oil, creating steam then converting pressurized force to mechanical energy by stirling engine etc. Collection of water from air also been explored by using simple metallic placates that are exposed to cold air of night for dew condensation. More advance methods such as refrigeration (using ammonia or other coolants) as well as thermo electricity and other technologies used, using electricity to reduce surface temperature of collection plates or fins, thereby condensation of moisture in the air. Electricity have been used for radiant heating by heating a coil and radiating the heat to desired direction.

### HISTORY OF INVENTION

Ancients knew about water condensation, naturally happening on cold and smooth surfaces of stones or leaves of trees or blades of grass. Dew ponds in Europe are results of such discovery. Mr. Mobasher grew up as teen agar in East of Tehran where they still had very old, non-electric ice houses that used high walls positioned in E-W direction, thereby creating low pressure zone created by cool nigh air coming from North. High walls created low air pressure between the walls, simulated high elevation, forcing water in pond to chill below freeze while actual local temperature was higher.

Research and development in heat exchanger, solar, thermo electricity and related green technology continued ever since, several solar, wind and water processing and harvesting technologies developed, followed up by to develop the current multiple output solar energy generator, water harvesting from air and Radiant Heater combination. Initial research focused on concentrated solar energy with combination of concentrated solar rays, focused on central collection system. Knowledge of solar energy, heat exchangers, water harvesting. Research pointed out that direction of heat is reversible by absorbing the heat from ambient air (heat pumping) and directing the collected heat for warming up desired space.

### ADVANTAGES OF THE PRESENT INVENTION

Current invention captures and processes the solar and natural energies in multiple utilization of space with minimal numbers of parts and technology in different ways:

1. Focuses sun's rays into a square solar dish by reduced shipping volume and utilization of energy in multiple cycles.

2. Concentrated solar rays, converted to electricity on photovoltaic cells in center of dish.

3. Difference between hot and cold utilized to create additional electricity in thermo electric modules in frontal heat exchanger (located above the secondary mirror, in focal point).

4. Heat of focused energy on photovoltaic cells transferred to thermoelectric modules below the heat exchanger and piped away to main radiators and connecting metallic frame. Difference of temperature in said thermo electric modules (in center of solar dish) and radiator surfaces converted to electricity.

5. Both heat exchangers (above and below the solar dish) can have circulating coolant (oil, water, sodium or even air) and further absorb the excess heat and pipe it away for further utilization (Stirling, steam engine or other methods) as well as storage for later use in night or when needed.

6. Majority of heat is radiated through the thin aluminum plates positioned on the backside of solar dish (shady side).

7. Entire metallic frame is also used as heat exchanger, further providing metal to air surface for heat dissipation or absorption as needed (chilling the dish, making radiant heater!).

8. All radiator surfaces (plates on back or entire frame) will collect moisture (dew) from the air at night. Dew will drip on collection surface positioned below for drinking, farming, animal or washing use.

9. Main radiator plates are square, allowing and parked in vertical position with corners pointing downward for better and more focused water collection by collecting drips right from the points of corners. An electric fan positioned in strategic location, improving ventilation on the radiator plates.

10. Stored electricity (in batteries or heat storage) can be revered to chill the radiator surfaces (radiator plates or frame) and creating heated opposite side of thermo electric modules thereby chilling and inducing better dew formation on metallic surfaces of radiators (behind the dish) or frame. This chilling effect further enhanced by selectively chilling only the back-radiator plates and piping excess heat through the metal frame or metallic surfaces of main dish and all other metallic surfaces.

11. Entire assembly is utilized as heat pump, capable of also collecting heat from the ambient air, or even when radiator surfaces submersed in dirt, water, covered with snow or ice. Heat collected from adjacent media (air, liquid, ice snow, dirt etc.>) and piped inward to the central dish and radiated to desired surface, this reverse combination is ideal for colder climates specially at night. Stored or direct electricity powers the current invention, providing pleasant Radiant hating for residential, animal husbandry or green house and farming use.

### OBJECTS OF THE INVENTION

It is an object of the invention to provide a diversified, multiple functional tools for production of electricity by recycling heat generated in multiple cycles. It is further object of current invention to collect water from air for drinking, farming, animal husbandry and washing or industrial use. It is also objective of current invention to absorb heat from adjacent media and provide utilizable heat for heating houses or other applications.

### SUMMARY OF THE INVENTION

The present invention is a combination of square, parabolic solar dish, concentrating solar rays to central collection cavity. Solar rays reflected to secondary mirror, positioned on focal point of dish where concentrated light is concentrated in the opening in center of the dish. Some of the heat absorbed by secondary mirror utilized in activating the frontal heat exchanger's thermo electric modular in the front of the unit (facing sun), producing electricity by temperature difference between the concentrated heat received by secondary mirror and radiator fins (facing the sun). Photo Voltaic (PV) cells (in center of Primary Dish) collects the energy of concentrated rays, producing electricity while chilling the PV cells, increasing efficiency. Excess heat is piped away by thermo electric modules sandwiched between hot side (attached to solar cells) and cold sides that is attached to big, square aluminum or other metallic plates acting as radiators.

BRIEF DESCRIPTION OF THE DRAWINGS.

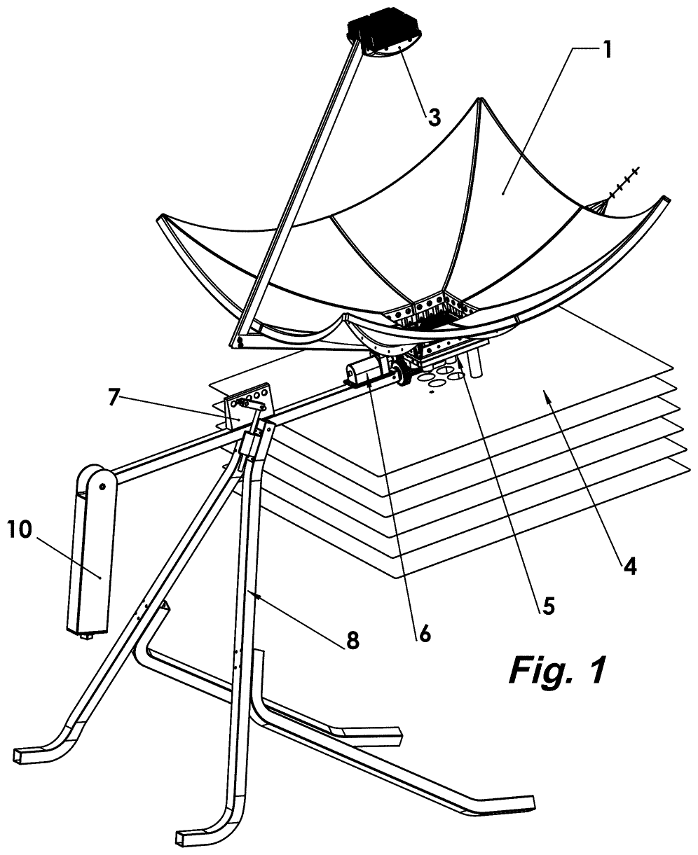

FIG. 1. Depicts the overall, isometric view of current invention.

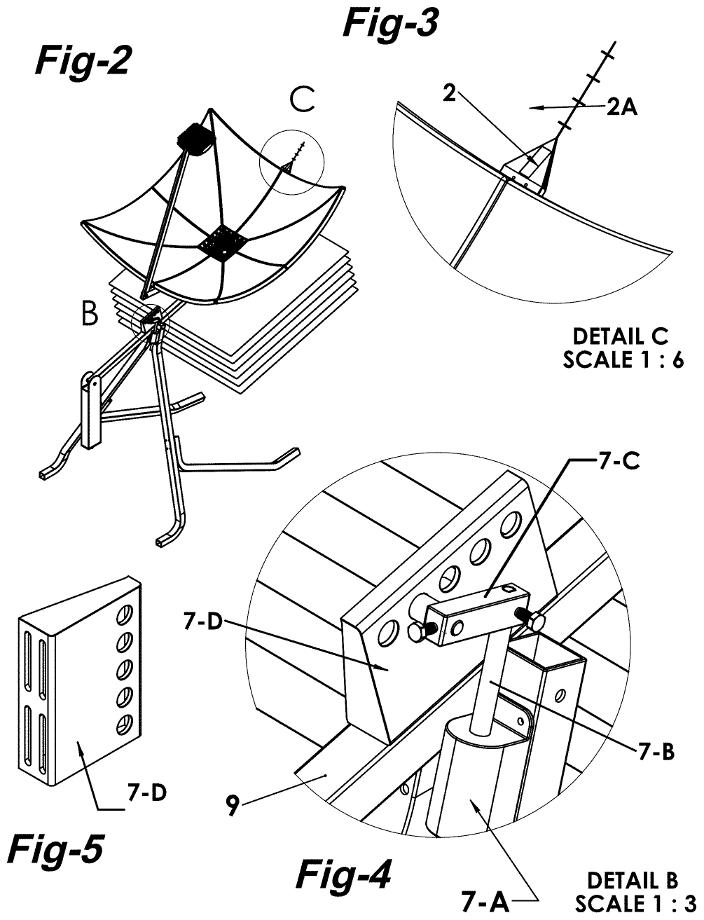

FIG. 2. Depicts the isometric view of the invention, in smaller scale. Important sections are encircled and enlarged in adjoining figures.

FIG. 3. Depicts the isometric view of directional light sensor.

FIG. 4. Depicts the isometric view of Elevation Control.

FIG. 5. Depicts the isometric view of Upper Elevation Plate, tuned on sides showing adjustment slots below.

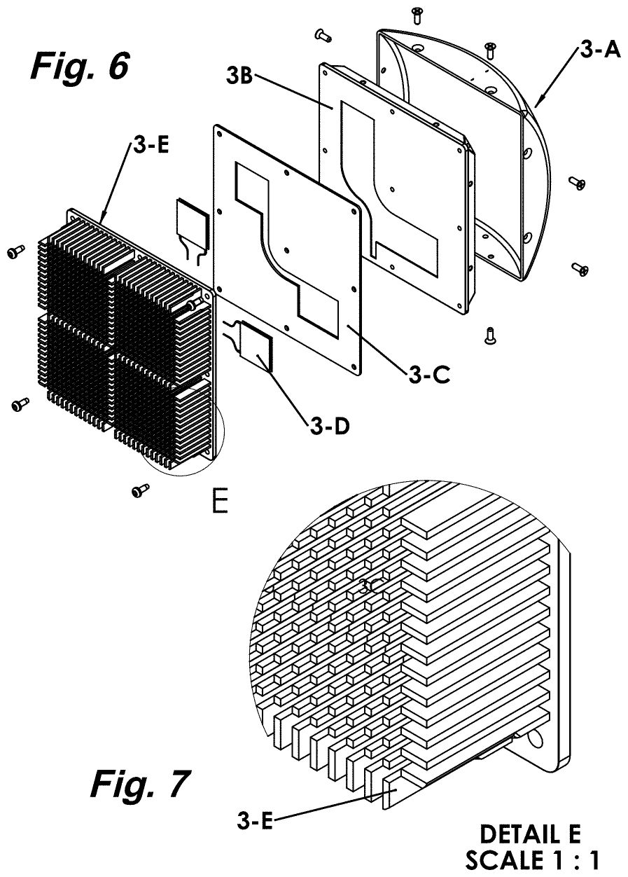

FIG. 6. Depicts the exploded view of Frontal or Upper Heat Exchanger.

FIG. 7. Depicts the enlarged view of radiator fin.

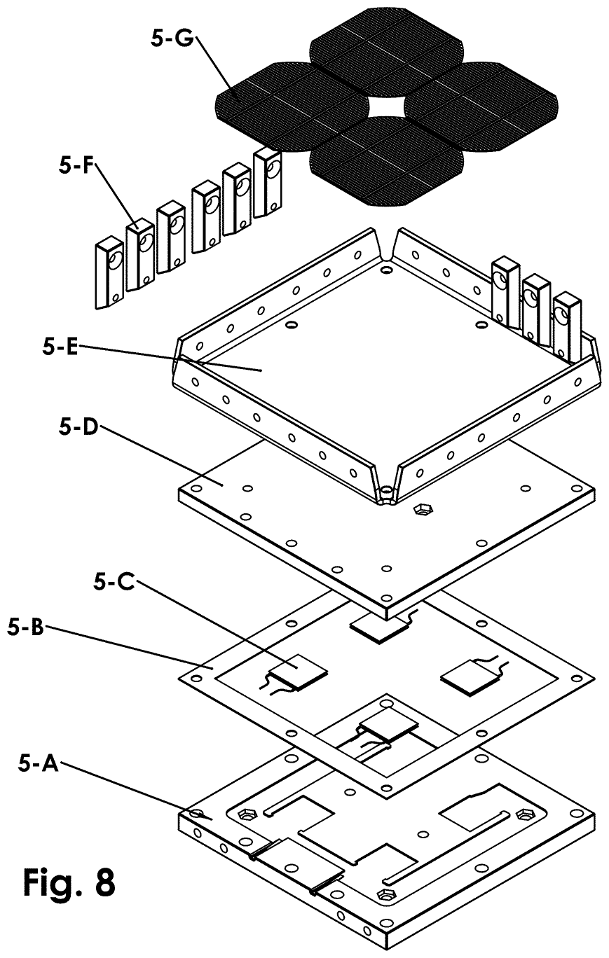

FIG. 8. Shows the exploded view of Central or secondary Heat Exchanger.

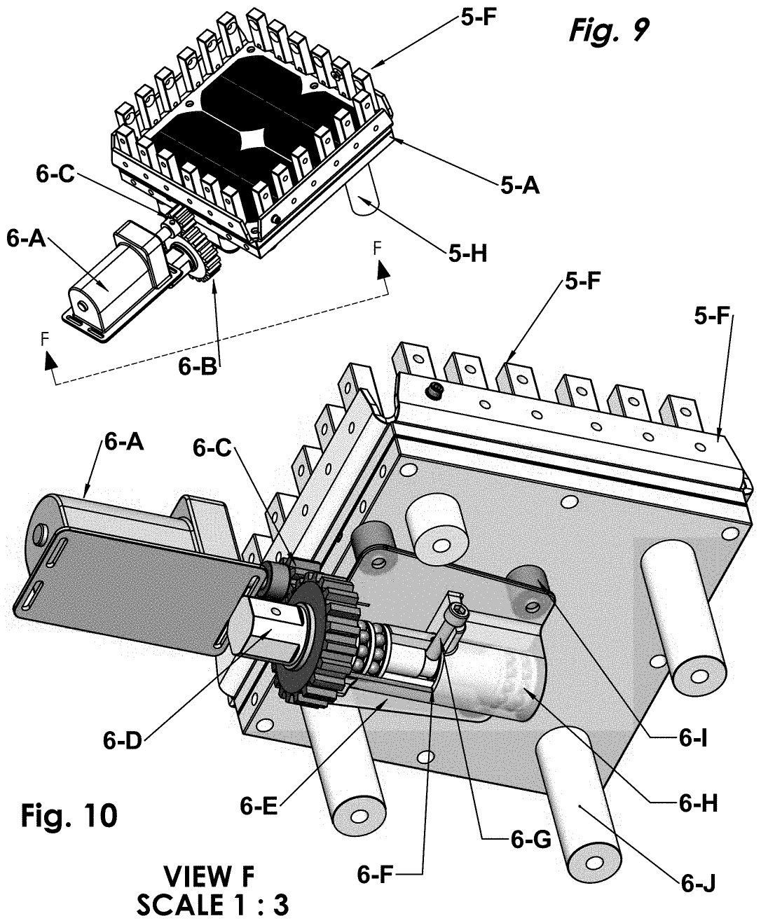

FIG. 9. Depicts the isometric view of secondary Heat Exchanger.

FIG. 10. Shows the lower view of Central Heat Exchanger, Ball Bearing casing made translucent to show interior details. Casing partially cut to show internal details. Azimuth control motor is visible in upper left side. Large gear shown with Pivoting Rod's square end, for mating with the Balance Square Tube (9).

### DETAILED DESCRIPTION OF THE EMBODIMENT(s):

Different parts of invention shown in appropriate assigned numbers;

1. Primary Mirror—Hemispherical mirror used in shape of square (for the most efficient shape), providing maximum shade for radiator plates (4). Mirror may also be made in round or other shapes. Each of the of the 8 (or more) segments are connected to neighboring segment by screws rivet or other fasteners (not shown). Edges are bent providing structural integrity.

2. Light Sensor—made in shape of 3-sided pyramid. Each side covered with a solar cell, sensing the light from 120 degrees. Tip is equipped with thin wires and multiple+shaped wires for deterring birds from sitting on structure and covering the mirror or sensitive cells with droppings.

3. Frontal Heat Exchanger—Reflects the focused light to central Heat Exchanger. Parts are: 3-A—Frontal Mirror—Reflects focused light from dish (1) to central Heat Exchanger (5-A), 3-B—Heat Sink—Screwed to 3-A, Frontal face having recessed nest to hold Thermo Electric Modules (3-D). Captures the heat from 3-A, 3-C—Insulator plate—Separates heat sink plate (3-B) and Radiator (3-E). 3-D—Thermo Electric Module—creates electricity by moving the heat from (3-B) and radiating it through (3-E).

4. Radiator Plates—made from thin and square aluminum sheets with rounded corner (for safety). These sheets radiate heat from Central Heat Exchanger (5) during the day and collect moisture from air at night or when polarity of electricity reversed in (5).

5. Central Heat Exchanger—collects focused light and heat on Photovoltaic cells and converts to electricity. Also capable of transmitting heated liquid or gas away for utilization of storage when heat transfer cavities provided. Parts are: 5-A—Base or Lower Heat Sink—Holds T-E modules in recessed nest. Wires (or thermal transfer media) exits from the bottom slots, carrying electricity or heat, 5-B—Insulator Gasket—separates 5-A and 5-B, avoiding the heat transfer between them, 5-C—Thermo Electric Module—creates electricity by absorbing heat from (5-A and 5-D) and radiating it through (Spacer Tubes 5-H), see next Fig., 5-D—Upper Heat Sink-Collects the heat from PV Cell Base (5-E), 5-E—PV Cell Base—holds Photo Voltaic Solar Cells, allows easy access for disassembly and replacement of solar cells, 5-F—Collector' Connectors—attaches segments of Solar Dish (1) to (5-E). Slots between segments are for ventilation, 5-G—Photo Voltaic Solar (PV) Cells—Collects solar energy and converts to electricity.

6. Azimuth Control Assembly—points the Dish (1) toward the sun depending on time of the day. Also turns the dish (1) and Radiator Plates (4) to vertical position for efficient dew collection at night or desired time. Entire assembly may be covered with protective cover to keep sand or debris or water away Mounting screws not shown. Parts are: 6-A—Azimuth Gear Motor. Have slots for lateral movements, compensating for adjustment to different sizes of gear, 6-B—. Large Gear—attached to shaft going through the Bearing housing below (5). This gear turns entire solar dish and (5) toward sun. Set screw secures (6-B) to (6-D), 6-C—Small Gear—Provides reduced and high torque power to turn solar collector assembly toward the sun. Set screw secures (6-C) to the derive shaft of (6-A), 6-D—Pivoting Rod—is the rotating hub for the dish. Square end attached to Balance Bar (9), main body is the shank, going through the Bearing Housing (6-E) holding the balls and racers in Bearing Housing (6-E), 6-E—Bearing Housing—Shown translucent for better viewing. Mounting screws not shown. Holds bearing parts, 6-F—Bearing Spacer—Holds bearings on both sides separated, 6-G—Pivoting Rod and Bearing Retainer screw—Passes through hole in (6-F). Fits in the groove of (6-D), keeping it in place, 6-H—Ball bearing=Thrust Bearing combinations—made from series of hardened washers (Race) with grooves. Balls provide friction reduction in both directions, 6-I—Bearing Insulation—Provides insulation from the heat, 6-J—Spacer Tubes—One is cut short for showing details. Made from aluminum or other heat-transferring materials such as copper etc. Separates Heat Exchanger (5) from the Heat Exchanger plates (4) below. Also transmits the excess heat to plates (4) for radiation, 7—Elevation Control Assembly—is an electric motor, with sliding or rotating rod, activating the connected parts, lifting or lowering the solar Dish (1) to proper angle for maximum alignment to sun depending on geological or seasonal locations. Entire assembly may be covered with protective cover to keep sand or debris or water away. Parts are: 7-A—Gear or stepper Motor. Attached to the Frame (8), 7-B—Actuator Rod—moves up and down to move connected Bracket (7-C), 7-C—Elevation bracket. Have hole to receive set screw, attached to (7-D). End have a threaded hold for locking screw, 7-D—Elevation Upper Bracket. Have slots below for adjustment and multiple holes to allow for adjustment according to location. Series of holes on top holds connecting shoulder screw, providing smooth pivoting. Friction free bushing or bearing may be added.

7. Frame—made of aluminum or other heat exchanging materials. Frame attached to the back of Central Heat Exchanger (5). Frame also absorbs and radiates heat from metallic surface.

8. Balance Bar—used for balancing the moving parts, also for securing Elevation and Azimuth Control.

9. Counter Weight—holds sand, gravel, stone, bricks, water or metals (lead or steel parts), creating balance between front and back of assembly. Access hole in bottom holds threaded cap, gasket added for liquids.

### HOW TO USE THE INVENTION

Current invention is used for combination of energy production and processing as well as dew harvesting or water collection from the air. After assembly of the parts elevation is adjusted to proper level depending on geographic location, assuring that maximum energy processing achieved when seasonal changes happen. Wiring then connected to energy storage unit such as battery or power grid. Light Sensor (2) will pick up incoming light from different directions, sending electrical signal to processing unit or computer (attached under the dish, not shown), Processor will determine intensity of light, activating the Elevation Control (7) and Azimuth Control (5) and automatically moves the dish toward the sun for maximum efficiency. Both heat exchangers (2 & 5) start working, producing electricity and heat for direct use or storage.

Dew and water harvesting are accomplished after sun goes down or dish is selectively turned away from sun. Heat Exchanger plates (4) turned to vertical of other angular positions that improves dew harvesting (utilizing proper wind movement, decreasing air pressure between plates for better efficiency), Corners of plates are pointed downward for more efficient flow of water droplets. Shallow pans, plastic, metallic, ceramic, clay or other collection arrangements or special container placed directly under dripping Water is piped away used directly or stored for later use. Entire assembly can be used as dew harvesting, collecting moisture from the air; large sheet of plastic or tarp placed under the assembly, collected water utilized or piped away as desired.

Heat generation achieved by reversing polarity of Thermo Electric Modules (3-D & 5-C). DC energy creates cold side in back side of the assembly, absorbing heat from the Radiator Plates (4) and connecting metal parts. Collected heat then radiated in opposite direction, to the central and frontal part of Central Heat Exchangers (3 and 5). Generated heat then radiated out like a search light or traditional radiant heater to desired direction such as campsite, toward the house, window etc. Special duct works placed between the house and generator where dish turned toward the duct or tunnel, radiating the heat directly through opening to the house, collection point or storage target. Access to the duct opened manually or automatically by computer or preset programming.

I claim:

1. A multiple output generator, comprising:
a light sensor, a frontal heat exchanger, a radiator plate, a central heat exchanger, and an azimuth control assembly; wherein the azimuth control assembly is configured to face toward a sun depending on a time of day.
